(19) United States
(12) Patent Application Publication
(10) Pub. No.: US 2009/0322163 A1
(43) Pub. Date: Dec. 31, 2009

(54) Green Piston Engine

(76) Inventor: David Walters, Willis, VA (US)

Correspondence Address: LATIMER & MAYBERRY IP LAW, LLP, 13873 PARK CENTER ROAD, SUITE 106, HERNDON, VA, 20171, US

(21) Appl. No.: 12/492,750

(22) Filed: Jun. 26, 2009

Related U.S. Application Data
(60) Provisional application No. 61/133,146, filed on Jun. 26, 2008.

(51) Int. Cl. H02K 7/075; H02K 21/00; H02N 11/00

(52) U.S. Cl. 310/20; 310/152; 415/916

(57) ABSTRACT

This invention relates to the field of engines. More particularly, the present invention relates to devices and methods used in the field of energy generation. Embodiments of the present invention provide environmentally friendly piston engines and/or the capability of retrofitting existing combustion engines to provide engines that run using no or little fuel. One embodiment of the invention includes an engine or retrofitting an internal combustion engine to provide for an engine comprising: (a) at least one crankshaft for providing mechanical power; (b) at least one magnetic piston operably connected to the crankshaft capable of turning the crankshaft with movement of the piston; and (c) an engine head comprising a magnet opposite each piston, which provides one or more magnet-piston pairs capable of producing a magnetic field between the magnet and piston; wherein each magnet-piston pair is capable of producing movement of the piston, and a corresponding turn or partial turn of the crankshaft, by a change in the magnetic field. For example, the change in magnetic field can alternate between an attractive force and no force between the magnet and piston, or between an opposing force and no force, or between an attractive force and an opposing force.

### CROSS-REFERENCE TO RELATED APPLICATIONS

This application relies on the disclosure and claims the benefit of the filing date of U.S. Provisional Application No. 61/133,146 filed Jun. 26, 2008, the disclosure of which is hereby incorporated by reference in its entirety.

### BACKGROUND OF THE INVENTION

1.Field of the Invention

This invention relates to the field of engines. More particularly, the present invention relates to devices and methods used in the field of energy generation. Embodiments of the present invention provide environmentally friendly piston engines and/or the capability of retrofitting existing combustion engines to provide engines that run using no or little fuel.

2. Description of the Related Art

There are many problems with current combustion engines. Combustion engines require the use of fuel, a resource that cannot be renewed. Depletion of this natural resource is rapidly accelerating in recent years due to over consumption for powering almost everything requiring electricity in our modern lives. Our reliance on this natural resource for powering vehicles further depletes this resource at rates at which this resource is expected to be completely depleted. Additionally, consumption of fuel necessarily has a negative effect on our environment by depleting greenhouse gases and adding noxious emissions to the air we breathe. What is needed are engines and power sources that operate on little to no fuel.

### SUMMARY OF THE INVENTION

Objects of the invention include to provide a climate that benefits mankind in all phases of “Green,” by defining a use of one of nature's oldest and little used products to cut emissions from any and all types of man's modern engines, and to make breathing quality better for our children and grandchildren. The present invention accomplishes these goals by providing engines that save on natural resources such as oil and gas.

Embodiments of the invention include retrofitting engines of any kind, such as combustion engines, with capability to operate using little or no fuel.

Further, embodiments of the invention are expected to be able to provide in the range of about 60 to 120 MPG, when using fuel. This is expected to drastically cut emissions to less than about 2%, which will make for a healthier living environment for us and reduce loss of our ozone layer.

With embodiments of the invention, smaller and/or more powerful engines are possible, where it is expected horsepower of a typical engine could be doubled. Engines can be made to operate more efficiently, thus, fuel consumption can also be cut to a fraction of what is currently used in today's global market.

### BRIEF DESCRIPTION OF THE DRAWING

FIG. 1 is a schematic diagram of an engine embodiment of the present invention.

### DETAILED DESCRIPTION OF VARIOUS EMBODIMENTS OF THE INVENTION

Reference will now be made in detail to various exemplary embodiments of the invention. The following detailed description is presented for the purpose of describing certain embodiments in detail and is, thus, not to be considered as limiting the invention to the embodiments described. Rather, the true scope of the invention is defined by the claims.

One embodiment of the invention includes an engine or retrofitting an internal combustion engine to provide for an engine comprising: (a) at least one crankshaft for providing mechanical power; (b) at least one magnetic piston operably connected to the crankshaft capable of turning the crankshaft with movement of the piston; and (c) an engine head comprising a magnet opposite each piston, which provides one or more magnet-piston pairs capable of producing a magnetic field between the magnet and piston; wherein each magnet-piston pair is capable of producing movement of the piston, and a corresponding turn or partial turn of the crankshaft, by a change in the magnetic field. For example, the change in magnetic field can alternate between an attractive force and no force between the magnet and piston, or between an opposing force and no force, or between an attractive force and an opposing force.

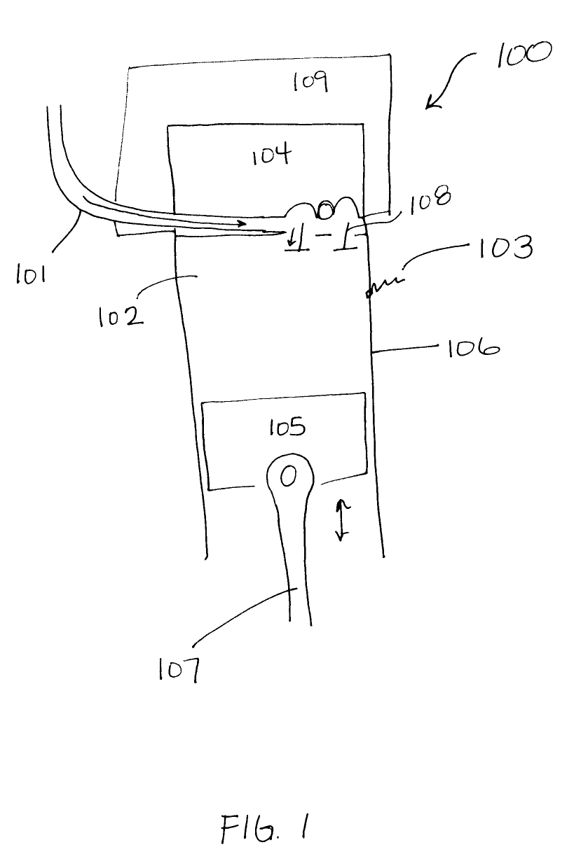

As shown in FIG. 1, the invention can be retrofitted to existing combustion engines 100. One or more magnets 104 can be incorporated into or replace part of engine head 109 and pistons 105. For example, in a four cylinder engine having four corresponding pistons, one or more iron ore magnets can be substituted for all or part of the heads of one or more piston. Likewise, a pulse magnet or electromagnet can be substituted or inserted into the engine head at a position to allow for movement of a piston toward or away from a magnet during use when the two components exert a magnetic or no magnetic field between them. A magnetic field that attracts then opposes the piston and magnet would be sufficient to cause up and down movement of the piston 105 within the cylinder 102. Other ways of achieving this movement can be caused by alternating between an attractive force and no force or between an opposing force and no force. As the piston 105 moves up and down in the chamber 105, it causes the crankshaft to rotate because it is operably connected to the crankshaft typically by way of an arm. Sealing rings and lubrication are typically used at the interface between the piston 105 and cylinder 106. As the piston 105 is moved away from the magnet 104 toward the bottom of the cylinder, 106 fuel is injected 101 into the combustion chamber 102 (space in each cylinder) in gaseous form through valves 108 in the engine head that open when the piston(s) are on a downward cycle. Typically, near the top of the upstroke of the piston a spark plug 103 provides a spark to ignite the fuel and push the piston down toward the bottom of the cylinder causing rotation or partial rotation of the crankshaft by way of arm 107. Magnets 104, whether on the engine head 109, the piston 105, or both, can be activated or deactivated at this point in the cycle to assist in or supply movement to the pistons 105.

Magnets can be used alone or in conjunction with the combustion features of the engine to cause movement of the pistons, and thus the crankshaft, which provides mechanical rotational energy, for example, for a vehicle or which can be harnessed to provide electrical energy, such as by way of a generator. If the magnets are used with combustion, then fuel efficiency of the engine can be increased because less fuel is needed to provide the force for moving the pistons. Instead, or in addition, the magnetic fields can be used to push and pull the pistons within the cylinders. Likewise, engine size can be dramatically reduced. For example, an eight cylinder engine can be the size of a four cylinder engine. This leads to more powerful smaller engines and increases fuel efficiency. Because the size of the engine can be reduced, for example the diameter of each piston can be the size of a quarter, the internal diameter of the cylinders can be reduced to just larger than a quarter, which necessarily reduces the volume within the cylinder available to accommodate the combustion. Accordingly, less fuel can be used to produce combustion within the smaller chamber. Efficiency can be further enhanced by changing the length of the rods connecting the pistons and crankshaft. For example, by shortening the rods, faster revolutions can be achieved.

The magnets need be of no special design, materials, or configuration. Any magnet could be used. The electromagnets can be of a size that allows for operation by way of a 6V, 12V, or 24V power source (battery). Any fuel, if needed, can be used including gas, oil, cooking oil, waste oil, ethanol, and methane. Engines operating on water or steam can also be enhanced with the features of this invention.

Embodiments of the present invention can be useful in one of many applications. For example, cars, buses, trucks, SUVs, tractor trailers, motorcycles, jet ski's, etc. can incorporate or be retrofitted with features of the invention to provide more powerful, compact, and fuel efficient vehicles. Electrical generators can also comprise the engines of the invention. Indeed, any application requiring production of mechanical or electrical energy can incorporate the features of the invention that allow for conversion of magnetic energy to lateral or rotational movement and then to electrical or mechanical power.

The present invention has been described with reference to particular embodiments having various features. It will be apparent to those skilled in the art that various modifications and variations can be made in the practice of the present invention without departing from the scope or spirit of the invention. One skilled in the art will recognize that these features may be used singularly or in any combination based on the requirements and specifications of a given application or design. Other embodiments of the invention will be apparent to those skilled in the art from consideration of the specification and practice of the invention. The description of the invention provided is merely exemplary in nature and, thus, variations that do not depart from the essence of the invention are intended to be within the scope of the invention.

What is claimed:

1. An engine comprising:
at least one crankshaft for providing mechanical power;
at least one magnetic piston operably connected to the crankshaft capable of turning the crankshaft with movement of the piston;
an engine head comprising a magnet opposite each piston, which provides one or more magnet-piston pairs capable of producing a magnetic field between the magnet and piston;
wherein each magnet-piston pair is capable of producing movement of the piston, and a corresponding turn or partial turn of the crankshaft, by a change in the magnetic field.

2. The engine according to claim 1, wherein the change in magnetic field alternates between an attractive force and no force between the magnet and piston, or between an opposing force and no force, or between an attractive force and an opposing force.
